(19) United States
(12) Patent Application Publication
(10) Pub. No.: US 2003/0089425 A1
(43) Pub. Date: May 15, 2003

(54) Plant and process for the separation of grey cast iron and aluminium mixed cuttings

(75) Inventors: Antonio Alvarez-Vega, Stolberg (DE); Willi Binnewies, Helmstedt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Durr Ecoclean GmbH, Filderstadt (DE)

(21) Appl. No.: 10/294,932

(22) Filed: Nov. 14, 2002

Related U.S. Application Data
(63) Continuation of application No. PCT/EP01/05275, filed on May 9, 2001.

(30) Foreign Application Priority Data
May 9, 2001 (WO) 01/89704
May 19, 2000 (DE) 10024771.7

(51) Int. Cl. H01F 1/03

(52) U.S. Cl. 148/101

(57) ABSTRACT

The invention relates to a device and a process for the separation of aluminium and grey cast iron cuttings from a cutting mixture. Herein, the cuttings are collected and fed to a first transport section (20). The cuttings are transported along the first transport section (20) and subjected to a magnetic field in such a way that due to the effect of gravity the aluminium cuttings leave the first transport section (20) at a first location (34), and the grey cast iron cuttings held by the magnetic attraction of the magnetic field, follow the first transport section (20) for a predetermined distance as far as a second location (36) and also leave this transport section (20) there, wherein the cuttings are gathered separately from one another at the first and second locations (34, 36).

This is a continuation of International Application No. PCT/EP01/05275, published in German under PCT Article 21(2) which is incorporated herein by reference in its entirety and for all purposes.

### FIELD OF THE INVENTION

The invention relates to a process for the separation of aluminium and grey cast iron cuttings from a cuttings mixture in accordance with the preamble of claim 1. The invention further relates to a process for machining cylinder crankcases on a production line, wherein cuttings produced during machining are collected, in accordance with the preamble of claim 8. The invention further relates to a device for collecting grey cast iron and aluminium mixed cuttings produced during a work piece machining process, in particular in the case of a production line for cylinder crankcases, in accordance with the preamble of claim 10. The invention further relates to a production line for machining work pieces made of aluminium or grey cast iron, in particular cylinder crankcases, in accordance with the preamble of claim 21.

### BACKGROUND OF THE INVENTION

During the machining of cylinder crankcases on a production line, grey cast iron or aluminium cuttings are produced depending on the material of the cylinder crankcase. Aluminium cuttings are valuable material and are collected on the production line and fed to a further processing system, which yields appropriate revenue. In this case, wet cuttings dropping during machining are collected at the end of a line by means of a scraper and are fed to a centrifuge to separate them from fluids. Devices for separating material residues and oils adhering to these are known from DE 30 43 220 C2 and from DEAS-21 29 874.

A treatment plant for coolants and lubricants containing cuttings, in which the cuttings are crushed, is known from DE 197 04 859 A1, for example. However, mixed cuttings remain unseparated in this plant.

DE 42 21 391 C1 describes a device for the recovery of waste materials coated with fluid, comprising clumps of cuttings, particles and small cuttings, from work piece machining processes. In this case, before the waste materials are crushed, these are separated according to type, i.e. clumps of cuttings, particles and small cuttings, in which case clumps of cuttings are separated off and only these are fed to a crushing device. The waste materials separated from the clumps of cuttings do not pass into the crushing plant, but are fed directly to a solid-liquid separation plant and are treated further there together with the crushed clumps of cuttings. However, the separation of mixed cuttings containing aluminium and grey cast iron cuttings is not possible with this plant.

However, when a changeover from cylinder crankcases made of grey cast iron to cylinder crankcases made of aluminium and vice versa is to occur on the very same production line, the production previously had to firstly be “run clean”, i.e. all cuttings from the previous material had to be removed before changing from one material to another, as otherwise unusable mixed cuttings are formed. However, this “clean run” is both costly and time-consuming.

Therefore, the object of the present invention is to provide a process and a device of the aforementioned type, wherein the aforementioned disadvantages can be overcome and cylinder crankcases made of different materials can be machined on a production line both economically and without any time delay.

### BRIEF SUMMARY OF THE INVENTION

This object is achieved according to the invention by a process of the aforementioned type with the steps specified in claim 1, by a process of the aforementioned type with the features characterised in claim 8, by a device of the aforementioned type with the features characterised in claim 10, and also by a production line of the aforementioned type with the features characterised in claim 21. Advantageous configurations of the invention are specified in the dependent claims.

To achieve the above-mentioned object with a process for the separation of aluminium and grey cast iron cuttings, the following steps are provided according to the invention:

(a) the cutting mixture is collected and this is fed to a first transport section,

(b) the cutting mixture is transported along the first transport section and subjected to a magnetic field in such a manner that due to the effect of gravity the aluminium cuttings leave the first transport section at a first location and the grey cast iron cuttings, held by the magnetic force of attraction of the magnetic field, follow the first transport section for a predetermined distance as far as a second location and also leave this transport section there, wherein the cuttings are gathered separately from one another at the first and second locations.

This has the advantage that precise separation of aluminium and grey cast iron cuttings according to sort is achieved without consideration that cylinder crankcases made of grey cast iron and aluminium are being machined in a mixed operation on the very same production line. This results in an improvement in revenue and increases the economic feasibility of the operation of a production line for cylinder crankcases.

For the initial separation of aluminium and grey cast iron cuttings, the mixed cuttings are expediently shaken on a vibration section after collection and before the first transport section.

To remove oil adhering to the cuttings, the cuttings are directed through an oil-dissolving rinsing bath on the first transport section.

To generate swirling movements which assist the separation and cleaning of the cuttings, the rinsing bath is subjected to ultrasonic energy.

In a preferred further development of the process, the following further steps are provided:

(c) the cuttings dropping from the first and second locations are transported respectively on a second and third transport section and

(d) the cuttings are dried, in particular by the action of thermal energy.

A further separation stage for an even higher degree of purity of the separated cuttings is achieved by the following steps:

(e) the cuttings dropping from the first and second locations are fed respectively onto a fourth and fifth transport section and

(f) the fourth and fifth transport sections are respectively subjected to a magnetic field in such a manner that due to the effect of gravity, the non-magnetic aluminium cuttings leave the respective transport section after a predetermined distance at a third location, whereas under the influence of the magnetic field, the magnetic grey cast iron cuttings leave the respective transport section at a fourth location spaced from the third location.

A three-stage separation of the cuttings dropping from the second location of the first transport section, which possibly also entrain non-magnetic aluminium cuttings, is achieved if in step (f), the cuttings dropping from the third location of the fifth transport section due to the effect of gravity are fed to the fourth transport section.

In a process for machining cylinder crankcases of the aforementioned type, it is provided according to the invention that on the production line cylinder crankcases of grey cast iron as well as cylinder crankcases of aluminium are machined directly one after the other and from the collected mixed cuttings grey cast iron cuttings are separated from aluminium cuttings.

This has the advantage that precise separation of aluminium and grey cast iron cuttings purely according to sort is achieved without consideration that cylinder crankeases made of grey cast iron and aluminium are being machined in a mixed operation on the very same production line. This results in an improvement in revenue and increases the economic feasibility of the operation of a production line for cylinder crankcases.

In a plant of the aforementioned type, it is provided according to the invention that it performs a separation of mixed cuttings into purely grey cast iron and aluminium cuttings.

This has the advantage that even in the case of arbitrary change during machining, for example, of cylinder crankcases made of grey cast iron or aluminium, a precise separation of aluminium and grey cast iron cuttings according to sort is assured. This results in an improvement in revenue and increases the economic feasibility of the operation of a production line for cylinder crankcases.

In a preferred embodiment, the cuttings separation device has a first transport section formed by two conveyor belts lying one against the other, wherein a device for generating a magnetic field is provided in such a manner that a magnetic force acts on magnetic cuttings in the direction of the upper conveyor belt in the direction of gravity, wherein the lower conveyor belt in the direction of gravity is set back relative to the upper conveyor belt contrary to the direction of transport, wherein further the end of the lower conveyor belt forms a first location of dropping cuttings and the end of the upper conveyor belt forms a second location of dropping cuttings. As a result, the non-magnetic aluminium cuttings already leave the first transport section at the end of the lower conveyor belt, whereas under the influence of the magnetic field the magnetic grey cast iron cuttings follow the first transport section to the end of the upper conveyor belt. This results in two locations at a distance from one another, at which grey cast iron and aluminium cuttings can be removed separately from one another under the effect of gravity.

For removal of the magnetic grey cast iron cuttings from the upper conveyor belt under the effect of gravity, the device for generating the magnetic field is configured such that the influence of the magnetic force on the magnetic grey cast iron cuttings ends at the end of the upper conveyor belt, and/or a scraping device for scraping off magnetic grey cast iron cuttings lying on the upper conveyor belt is provided at the end of the upper conveyor belt.

For removing oil residues adhering to the cuttings, a rinsing bath is provided, into which the first transport section at least partially dips.

For detaching any lumps of mixed cuttings, which may have formed, and to assist the cutting cleaning process, a device for subjecting the rinsing bath to ultrasonic energy is provided.

After the first transport section a device for drying the cuttings is expediently provided which subjects the cuttings to thermal energy and comprises a radiant heater, for example.

In a preferred embodiment, a second transport section associated with the first location and a third transport section associated with the second location are provided, which respectively transport cuttings dropping from the first and second locations due to the effect of gravity to a fourth and fifth transport section.

For further separation of grey cast iron and aluminium cuttings, a device forming a magnetic field is respectively disposed at the fourth and fifth transport sections, wherein the magnetic field and the fourth or fifth transport section are respectively configured such that due to the effect of gravity the non-magnetic aluminium cuttings leave the respective transport section after a predetermined distance at a third location, whereas under the influence of the magnetic field the magnetic grey cast iron cuttings leave the respective transport section at a fourth location spaced from the third location.

As a result of the fifth transport section being disposed above the fourth transport section in the direction of gravity in such a manner that the cuttings dropping from the third location of the fifth transport section fall onto the fourth transport section, a three-stage separation of the respective sorts of cuttings with a high degree of purity is achieved.

### BRIEF DESCRIPTION OF THE DRAWING

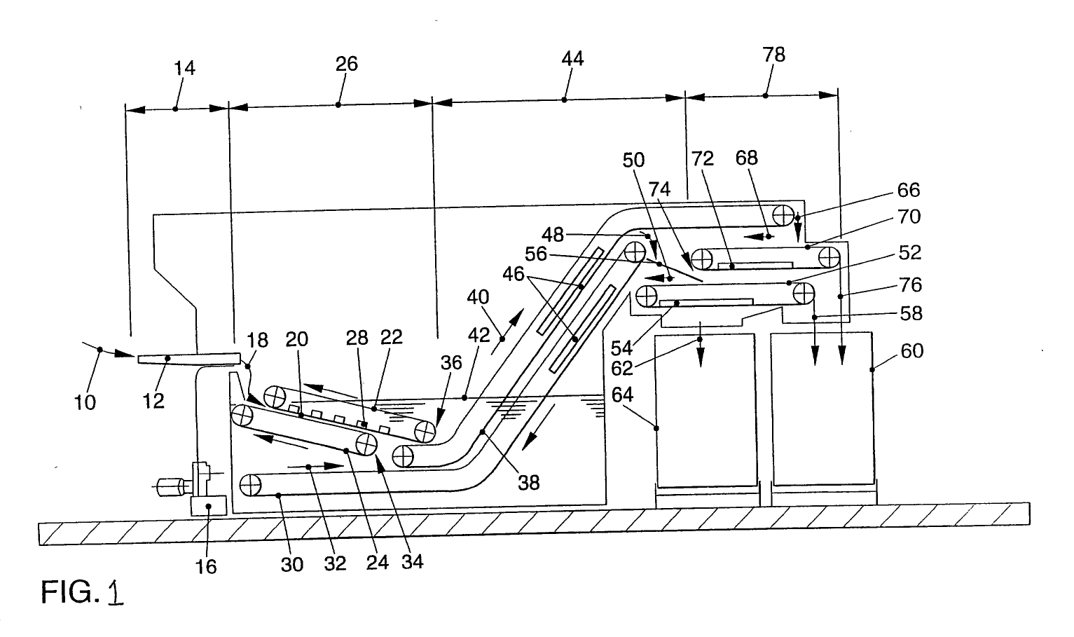

Further features, advantages and advantageous configurations of the invention result from the dependent claims and also from the following description of the invention on the basis of the attached drawing. This shows, in a single FIG. 1, a schematic sectional view of a preferred embodiment of a device according to the invention for conducting the process according to the invention.

### DETAILED DESCRIPTION OF THE INVENTION

In the preferred embodiment shown schematically in the single FIGURE of a device according to the invention for the separation of cuttings, a corresponding mixture of cuttings is fed at 10 to a vibration section 12 in a first zone 14. The fed mixture of cuttings generally comprises grey cast iron cuttings which are granular in structure, and aluminium cuttings which are spiral in shape. This results in an appropriate preliminary separation by shaking in the first zone 14. A vapour extraction process is conducted simultaneously while the mixture of cuttings is being shaken for preliminary separation of grey cast iron and aluminium cuttings by means of a shaking device 16. At the end of the shaking section 12, the pre-separated mixed cuttings drop at 18 due to the effect of gravity onto a first transport section 20, which is formed by two conveyor belts 22 and 24.

This first transport section 20 is located in a second zone 26. In this second zone 26 the mixed cuttings are directed along the first transport section 20 by means of the two conveyor belts 22 and 24, corresponding devices 28 or magnets 28 for generating a magnetic field being provided in the region of the conveyor belt 22 located at the top in the direction of gravity. The magnetic field of these magnets 28 leads to an application of force onto the magnetic grey cast iron cuttings contrary to the direction of gravity, so that the grey cast iron cuttings essentially adhere to the conveyor belt 22. Contrary to this, the aluminium cuttings have no magnetic properties whatsoever and remain uninfluenced by the magnetic field. Since the conveyor belt 24 located at the bottom in the direction of gravity is set back contrary to the direction of transport, at the end of the conveyor belt 24 the aluminium cuttings therefore drop onto the conveyor belt 30 which forms a second transport section 32. In this case, the aluminium cuttings drop at a first location 34 from the conveyor belt 24 onto the conveyor belt 30 due to the effect of gravity.

Conversely, due to the magnetic attraction in region of the conveyor belt 22, the grey cast iron cuttings follow the first transport section 20, past the first location 34, and only at the end of the conveyor belt 22 at a second location 36, drop onto a conveyor belt 38, which forms a third transport section 40. In the second zone 26, the first transport section 20 is additionally directed through a washing bath 42, which removes oils adhering to the cuttings and thus washes these cuttings. A bath temperature amounts to 60°, for example, and a cleaning agent in the form of a neutral cleaning agent is expediently added to the washing bath. To assist in cleaning the cuttings, a flow of washing bath liquid 42 is generated along the first transport section 20 at approximately 2 bar contrary to the direction of transport by means of flow nozzles. Moreover, it is particularly preferred to subject the washing bath 42 to ultrasound, as result of which any lumps of cuttings as well as oils and contaminants adhering to the cuttings are removed. Hence, in summary, in the second zone 26 a wet separation of the cuttings occurs as a result of magnets 28 as well as cleaning of the cuttings.

The second and third transport section 32, 40 of the conveyor belts 30, 38 leads through a third zone 44, in which a radiant heater 46 is respectively associated with each conveyor belt 30 and 38. These radiant heaters 46 dry the cuttings directed past them on the conveyor belts 30, 38 in the third zone 44. In this case, conveyor belt 38 essentially directs grey cast iron cuttings with residual aluminium cuttings and conveyor belt 30 essentially transports aluminium cuttings with residual grey cast iron cuttings.

At 48 the aluminium cuttings with residual grey cast iron cuttings of conveyor belt 30 drop onto the fourth transport section 50, which is formed by a conveyor belt 52 and has a magnet 54. Here, the aluminium cuttings with residual grey cast iron cuttings pass via a chute 56 onto the conveyor belt 52 of the fourth transport section 50. As a result of the magnetic interaction between the magnet 54 and the residual grey cast iron cuttings, these adhere to the conveyor belt 52 along the entire fourth transport section and at a fourth location 58 of the fourth transport section 50 drop into a container 60 for grey cast iron cuttings. Since in contrast the aluminium cuttings are not magnetic, these do not follow the fourth transport section 50, but before this drop into a container 64 for aluminium cuttings at a third location 62 of the fourth transport section 50.

The grey cast iron cuttings with residual aluminium cuttings transported by conveyor belt 38 on the third transport section 40 drop onto a fifth transport section 68 at 66 due to the effect of gravity. This fifth transport section 68 is formed by a conveyor belt 70, which also has a magnet 72. Following the same mechanism outlined with respect to conveyor belt 52, aluminium cuttings located on the fifth transport section 68 at a third location 74 of the fifth transport section 68 drop onto the conveyor belt 52 of the fourth transport section 50, where subsequent separation once again occurs in the aforementioned manner. In contrast, corresponding grey cast iron cuttings follow the fifth transport section 68 and at a fourth location 76 of the fifth transport section 68 drop directly into the container 60 for grey cast iron cuttings.

In other words, a dry subsequent separation occurs in two stages in the fourth zone 78 by means of magnets. Thus, a three-stage separation with a high degree of purity occurs overall. As a result of this, appropriate revenue from the sale of collected aluminium cuttings can be assured even with the mixed machining of cylinder crankcases made of aluminium and grey cast iron on a single production line. As a result of the separation device for aluminium and grey cast iron cuttings according to the invention, fluctuations in piece numbers between aluminium and grey cast iron can be absorbed without any problem.

The two cuttings containers 60 and 64 are mounted on corresponding carriages which can be driven out transversely to the direction of transport of the cuttings. In addition, in the third zone 54 a vapour extraction process is advantageously conducted to further assist the drying of the cuttings by the radiant heaters 46. The magnets used in the respective zones 26 and 78 are provided in the form of electromagnets, for example.

1. Process for the separation of aluminium and grey cast iron cuttings from a mixture of cuttings with the following steps:
(a) the cutting mixture is collected and this is fed to a first transport section,
(b) the cutting mixture is transported along the first transport section and subjected to a magnetic field in such a manner that due to the effect of gravity the aluminium cuttings leave the first transport section at a first location and the grey cast iron cuttings, held by the magnetic attraction of the magnetic field, follow the first transport section for a predetermined distance as far as a second location and also leave this transport section there, wherein the cuttings are gathered separately from one another at the first and second locations.

2. Process according to claim 1, characterised by the following additional step before step (b):
(a1) the cutting mixture is shaken on a vibration section.

3. Process according to claim 1 characterised in that the cuttings are directed through an oil-dissolving rinsing bath on the first transport section.

4. Process according to claim 3, characterised in that the rinsing bath is subjected to ultrasonic energy.

5. Process according to claim 1, characterised by the following further steps:
(c) the cuttings dropping from the first and second locations are transported respectively on a second and third transport section and
(d) the cuttings are dried, in particular by the action of thermal energy.

6. Process according to claim 1, characterised by the following further step:
(e) the cuttings dropping from the first and second locations are fed respectively onto a fourth and fifth transport section and
(f) the fourth and fifth transport sections are respectively subjected to a magnetic field in such a manner that due to the effect of gravity the non-magnetic aluminium cuttings leave the respective transport section after a predetermined distance at a third location, whereas under the influence of the magnetic field the magnetic grey cast iron cuttings leave the respective transport section at a fourth location spaced from the third location.

7. Process according to claim 6, characterised in that in step (f), the cuttings dropping from the third location of the fifth transport section due to the effect of gravity are fed to the fourth transport section.

8. Process for machining cylinder crankcases on a production line, wherein cuttings produced during machining are collected, characterised in that on the production line cylinder crankcases of grey cast iron as well as cylinder crankcases of aluminium are machined directly one after the other and from the collected mixed cuttings grey cast iron cuttings are separated from aluminium cuttings.

9. Process according to claim 8, characterised in that the separation of the cuttings is conducted in accordance with the process according to at least one of claims 1 to 7.

10. Plant for collecting grey cast iron and aluminium cuttings produced during a work piece machining process, in particular in the case of a production line for cylinder crankcases, characterised in that this plant has a cuttings separation device for separation of grey cast iron and aluminium cuttings present in the form of mixed cuttings.

11. Plant according to claim 10, characterised in that the cuttings separation device has a first transport section (20) formed by two conveyor belts (22, 24) lying one against the other, wherein a device (28) for generating a magnetic field is provided in such a manner that a magnetic force acts on magnetic cuttings in the direction of the upper conveyor belt (22) in the direction of gravity, wherein the lower conveyor belt (24) in the direction of gravity is set back relative to the upper conveyor belt (22) contrary to the direction of transport, wherein further the end of the lower conveyor belt (24) forms a first location (34) of dropping cuttings and the end of the upper conveyor belt (22) forms a second location (36) of dropping cuttings.

12. Process according to claim 11, characterised in that the device (28) for generating the magnetic field is configured such that the influence of the magnetic force on the magnetic grey cast iron cuttings ends at the end (36) of the upper conveyor belt (22).

13. Plant according to claim 1, characterised in that a scraping device for scraping off magnetic grey cast iron cuttings lying on the upper conveyor belt (22) is provided at the end (36) of the upper conveyor belt (22).

14. Plant according to claim 11, characterised in that a rinsing bath (42) is provided, into which the first transport section (20) at least partially dips.

15. Plant according to claim 14, characterised in that a device for subjecting the rinsing bath (42) to ultrasonic energy is provided.

16. Plant according to claim 11, characterised in that after the first transport section (20) a device (46) for drying the cuttings is provided.

17. Plant according to claim 16, characterised in that the device (46) for drying the cuttings is configured such that it subjects the cuttings to thermal energy, in particular such that it comprises a radiant heater (46).

18. Plant according to claim 11, characterised in that a second transport section (32) associated with the first location (34) and a third transport section (40) associated with the second location (36) are provided, which respectively transport cuttings dropping from the first and second locations (34, 36) due to the effect of gravity to a fourth and fifth transport section (50, 68).

19. Plant according to claim 18, characterised in that a device (54, 72) forming a magnetic field is respectively disposed at the fourth and fifth transport sections (50, 68), wherein the magnetic field and the fourth or fifth transport sections (50, 68) are respectively configured such that due to the effect of gravity the non-magnetic aluminium cuttings leave the respective transport section (50, 68) after a predetermined distance at a third location (62, 74), whereas under the influence of the magnetic field the magnetic grey cast iron cuttings leave the respective transport section (50, 68) at a fourth location (58, 76) spaced from the third location (62, 74).

20. Plant according to claim 19, characterised in that the fifth transport section (68) is disposed above the fourth transport section (50) in the direction of gravity in such a manner that the cuttings dropping from the third location (74) of the fifth transport section (68) fall onto the fourth transport section (50).

21. Plant for machining work pieces made of aluminium or grey cast iron, in particular cylinder crankcases, characterised in that it has a device for collecting cuttings in accordance with claim 10.
